(19) United States
(12) Patent Application Publication
(10) Pub. No.: US 2018/0357733 A1
(43) Pub. Date: Dec. 13, 2018

(54) OCCUPANCY REVIEWS OF SPACES

(71) Applicant: Honeywell International Inc., Morris Plains, NJ (US)

(72) Inventors: Roshan Lawrence Valder, Bangalore (IN); Rajkumar Palanivel, Bangalore (IN); Ananya Vetal, Bangalore (IN); Sanjay Roy, Plymouth, MN (US); Aditya Arun, Patna (IN)

(21) Appl. No.: 15/619,231

(22) Filed: Jun. 9, 2017

(51) Int. Cl. G06Q 50/16; G06Q 30/02; G06F 17/30; G06F 3/0482; H04W 4/02

(52) U.S. Cl. CPC G06Q 50/163; G06Q 30/0282; H04W 4/02; G06F 17/3087; G06F 3/0482; G06F 17/30867

(57) ABSTRACT

Methods, devices, and systems for occupancy reviews of spaces are described herein. One device includes a memory, and a processor to execute executable instructions stored in the memory to receive occupant reviews from mobile devices regarding spaces in a building, generate a feedback dashboard based on the received occupant reviews from the mobile devices regarding the spaces in the building, and a user interface to display the feedback dashboard in a display.

### TECHNICAL FIELD

The present disclosure relates to methods, devices, and systems for occupancy reviews of spaces.

### BACKGROUND

Buildings can include different spaces for various uses. For example, a lobby of a building can serve as an entrance hall or anteroom, an office can serve as a space where business of a professional, commercial, industrial, or other type of organization can be conducted, a conference room can serve as a space to meet with other people, etc.

Some people may prefer some building spaces more than others for various reasons. In some examples, a first person may enjoy a conference room as a result of a type of chair located in the conference room, whereas a second person may not enjoy the conference room as they may not care for the type of chair located in the conference room. In some examples, a person may not enjoy an office as a result of a light in the office malfunctioning.

Feedback regarding a building space may be conveyed as a result of a negative experience by an occupant of the building space. For example, an occupant may not prefer working in a particular office as a result of a malfunctioning light in the particular office. Conveying negative feedback regarding the malfunctioning light may involve accessing complex web portals or dialing a help line using a telephone. Further, there may not be system to allow an occupant to provide positive feedback regarding the building space.

### BRIEF DESCRIPTION OF THE DRAWINGS

FIG. 1 is an example of a system for occupancy review of spaces, in accordance with one or more embodiments of the present disclosure.

FIG. 2A is an example of an illustration of a display provided on a user interface of a mobile device showing a space review, generated in accordance with one or more embodiments of the present disclosure.

FIG. 2B is an example of an illustration of a display provided on a user interface of a mobile device showing a space review with tags for a conference room, generated in accordance with one or more embodiments of the present disclosure.

FIG. 2C is an example of an illustration of a display provided on a user interface of a mobile device showing a space review with tags for a lobby, generated in accordance with one or more embodiments of the present disclosure

FIG. 3 is an example of an illustration of a display provided on a user interface of a mobile device showing a space recommendation, generated in accordance with one or more embodiments of the present disclosure.

FIG. 4 is an example of an illustration of a display provided on a user interface of a computing device showing a feedback dashboard, generated in accordance with one or more embodiments of the present disclosure.

FIG. 5 is an example of a computing device and a mobile device for occupancy review of spaces, in accordance with one or more embodiments of the present disclosure.

### DETAILED DESCRIPTION

Methods, devices, and systems for occupancy reviews of spaces are described herein. In some examples, one or more embodiments include a memory, and a processor to execute executable instructions stored in the memory to receive occupant reviews from mobile devices regarding spaces in a building, generate a feedback dashboard based on the received occupant reviews from the mobile devices regarding the spaces in the building, and a user interface to display the feedback dashboard in a display.

Occupancy reviews of spaces, in accordance with the present disclosure, can provide a way for occupants of spaces to provide occupant reviews of the spaces in a building. The occupant reviews can provide a way for a facility manager or other persons of a building to receive feedback regarding spaces of the building.

Utilizing the feedback regarding the spaces of the building, the facility manager can determine which spaces occupants enjoy. The facility manager can determine which spaces occupants may not enjoy by reviewing negative occupant reviews. The facility manager can then improve the spaces with negative occupant reviews.

Feedback regarding the spaces of the building may be used by other occupants. The feedback may help other occupants by providing the other occupants with information about a quality of a building space.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

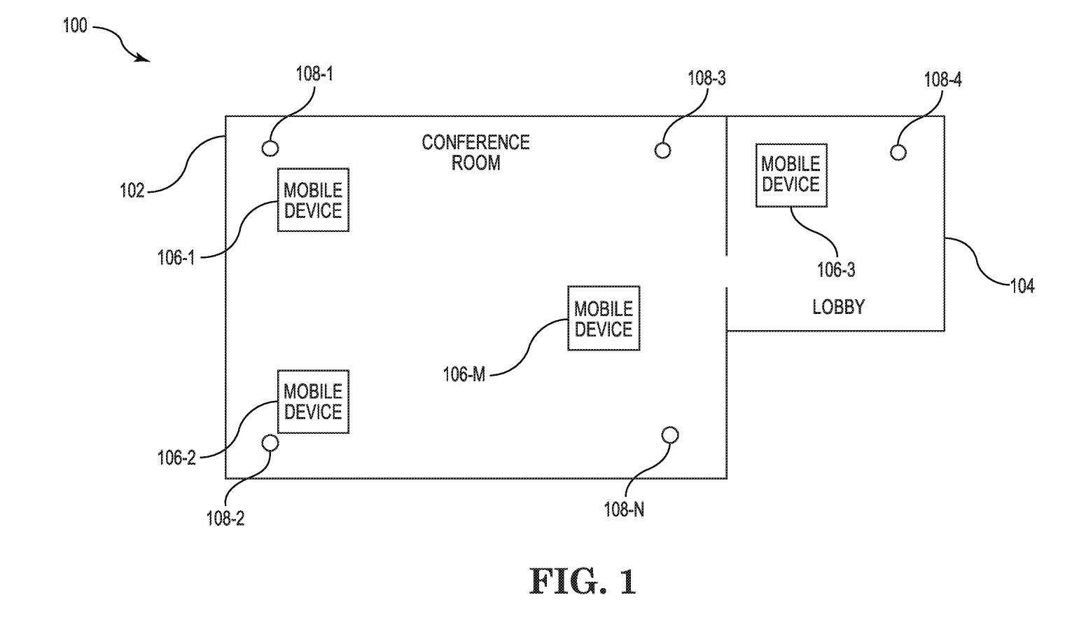

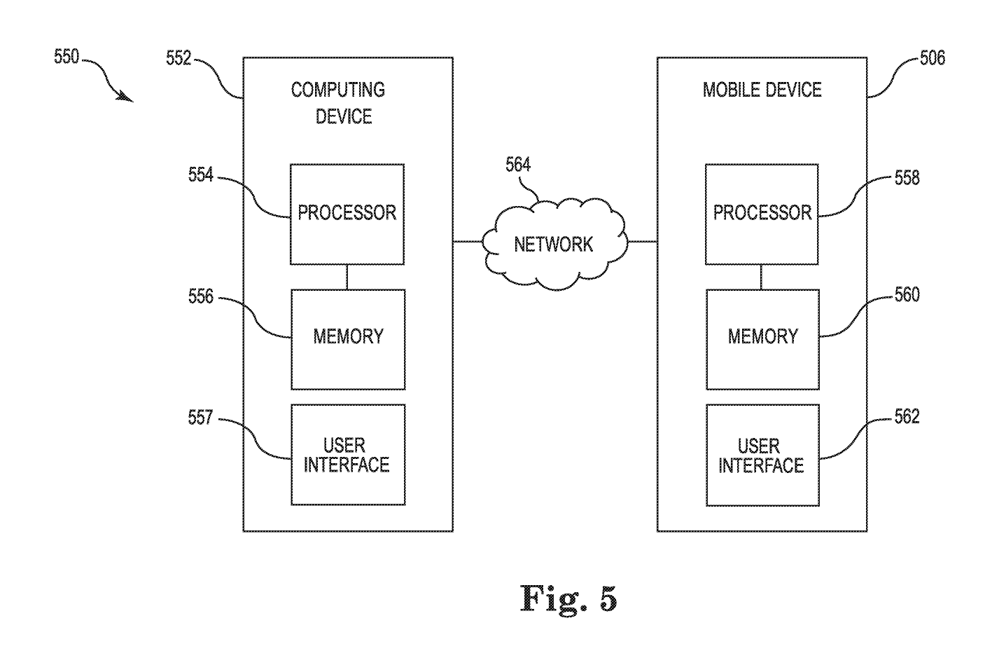

The figures herein follow a numbering convention in which the first digit or digits correspond to the drawing figure number and the remaining digits identify an element or component in the drawing. Similar elements or components between different figures may be identified by the use of similar digits. For example, 106 may reference element “06” in FIG. 1, and a similar element may be referenced as 506 in FIG. 5.

FIG. 1 is an example of a system 100 for occupancy review of spaces, generated in accordance with one or more embodiments of the present disclosure. As illustrated in FIG. 1, the system 100 can include conference room space 102, lobby space 104, mobile devices 106-1, 106-2, 106-3, 106-M (referred to collectively as mobile devices 106), and beacons 108-1, 108-2, 108-3, 108-4, 108-N (referred to collectively as beacons). As used herein, a building space can, for example, refer to a part of a building which may be separated by walls or partitions from other parts of the building.

Mobile devices 106 can determine their locations in a building. For example, mobile device 106-1 can communicate with beacons 108 to determine that mobile device 106-1 is located in conference room space 102, and mobile device 106-3 can communicate with beacons 108 to determine that mobile device 106-3 is located in lobby space 104.

Although the building is shown in FIG. 1 and is described as including two spaces (e.g., conference room space 102 and lobby space 104), embodiments of the present disclosure are not so limited. For example, the building can include more than two spaces (e.g., offices, kitchens, cubicle spaces, bathrooms, etc.) or less than two spaces.

The location of each mobile device 106 can be determined using location beacons 108 located in the building. In some examples, conference room space 102 can include location beacons 108-1, 108-2, 108-3, 108-N, where mobile devices 106 can utilize location beacons 108-1, 108-2, 108-3, 108-N to determine mobile devices located in conference room space 102. In some examples, lobby space 104 can include location beacon 108-4 to determine mobile devices located in lobby space 104. In other words, spaces of the building can include location beacons 108 to determine a respective space in the building in which mobile devices 106 are located. Location beacons 108 can be Bluetooth beacons that can have a predetermined location in the building that can communicate with mobile devices 106 such that the mobile devices 106 can determine their locations in the building.

As used herein, a mobile device can include devices that are (or can be) carried and/or worn by a user. For example, mobile devices 106 can be a phone (e.g., a smart phone), a tablet, a personal digital assistant (PDA), smart glasses, and/or a wrist-worn device (e.g., a smart watch), among other types of mobile devices

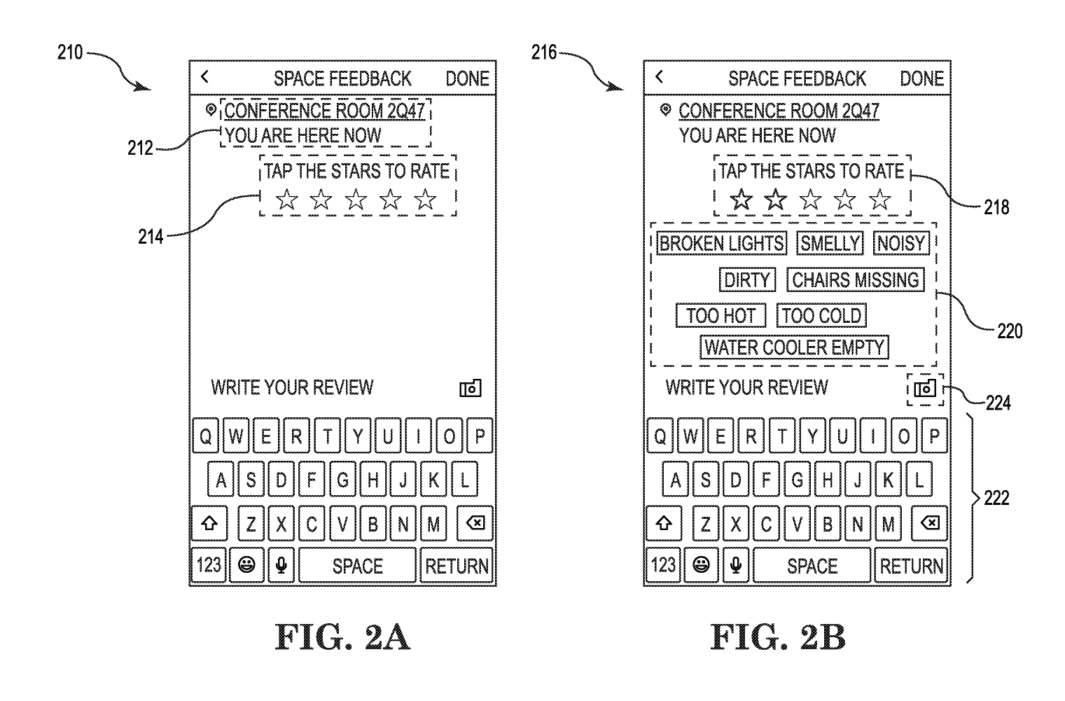

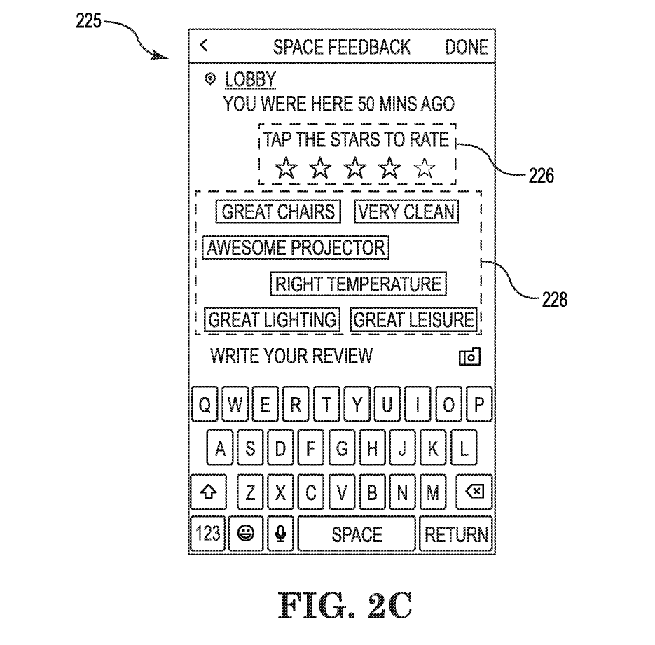

FIGS. 2A, 2B, and 2C illustrate examples of an illustration of a display provided on a user interface of a mobile device (e.g., mobile devices 106, previously described in connection with FIG. 1) showing a space review. FIG. 2A is an example of an illustration of a display provided on a user interface of a mobile device showing a space review 210, generated in accordance with one or more embodiments of the present disclosure. As illustrated in FIG. 2A, space review 210 can include location of the mobile device 212 and occupant review selection 214.

The mobile device can generate an occupant review selection 214 of a space corresponding to the location 212 of the mobile device. For example, the mobile device can determine a location 212 in the building. For instance, as illustrated in FIG. 2A, the mobile device can be located in “Conference Room 2Q47”. Conference Room 2Q47 can correspond to conference room 102, previously described in connection with FIG. 1.

Location 212 can be a location of the mobile device in a building. For instance, in an example in which the mobile device is located in a lobby of the building, location 212 can be the lobby of the building, among other locations in the building.

In some examples, the mobile device can receive a location search query. For example, a user may input a space the user thinks they are in via the mobile device to search for the space. For instance, a user may input into the mobile device a location search query “conference room” to search for conference room spaces. The mobile device can generate a list of conference room spaces relating to the location search query.

The mobile device can determine the location of the mobile device in response to a selection of a location via the location search query. For example, the user may review the list of conference room spaces and select “Conference Room 2Q47 as the location of the mobile device in the building. The mobile device can determine the location of the mobile device to be Conference Room 2Q47 via a user input to the mobile device.

Occupant review selection 214 can be a rating of a space the mobile device is located in. For example, a user of the mobile device may like various aspects of Conference Room 2Q47 and may give the conference room a rating, as is further described in connection with FIG. 2B.

As illustrated in FIG. 2A, occupant review selection 214 can be a rating based on a selection of “stars”. In some examples, a user can rate a space they do not particularly like by rating the space one star. In some examples, a user can rate a space they like very much by rating the space four stars or five stars. In some examples, a user may be like certain aspects of the space but not others, and can rate the space two stars or three stars.

Although occupant review selection 214 is illustrated in FIG. 2A and described above as being a “star” rating system, embodiments of the present disclosure are not so limited. For example, occupant review selection 214 can be a number rating system (e.g., selection of a numeral “1” rating is bad, selection of a numeral “10” is good), a textual rating system (e.g., selection of a textual option “Dislike” is bad, selection of a textual option “Like” is good), a “Like” rating system using graphics or other visuals (e.g., selection of a “thumb-down” icon is bad, selection of a “thumb-up” icon is good), among other rating systems.

FIG. 2B is an illustration of a display provided on a user interface of a mobile device showing a space review 216 with tags 220 for a conference room, generated in accordance with one or more embodiments of the present disclosure. As illustrated in FIG. 2B, space review 216 can include occupant review 218, tags 220, keyboard 222, and photograph submission 224.

The mobile device can receive an occupant review 218 of the space via a user input. For example, a user of the mobile device can rate the space the mobile device is located in by giving an occupant review 218. For instance, as illustrated in FIG. 2B, a user can rate Conference Room 2Q47 by giving an occupant review 218 via a user input to an occupant review selection (e.g., occupant review selection 214, previously described in connection with FIG. 2A). In other words, a user can give an occupant review 218 to rate the space the mobile device is located in by selecting a star rating on the user interface of the mobile device.

For example, as illustrated in FIG. 2B, the user of the mobile device can give a two star rating as occupant review 218 for Conference Room 2Q47. The user may not particularly like Conference Room 2Q47 for various reasons. The user can specify the various reasons for the two star rating for occupant review 218, as is further described herein.

The mobile device can generate tags 220 in response to receiving occupant review 218. Tags 220 can be generated according to the rating of the space for occupant review 218. For example, as described above, the user of the mobile device may give a two star rating for occupant review 218 for various reasons. Tags 220 can be generated as a result of the two star rating with which the user can select reasons for the two star rating for occupant review 218.

As illustrated in FIG. 2B, tags 220 generated in response to a two star rating can include “broken lights”, “smelly”, “noisy”, “dirty”, “chairs missing”, “too hot”, “too cold”, and “water cooler empty”. The user of the mobile device can select various tags related to the reasoning for the two star rating. For example, the user may have given Conference Room 2Q47 a two star rating as a result of the conference room being noisy, chairs missing, and the temperature of the conference room being too hot, among other reasons for the two star rating.

Tags 220 can be predetermined. For example, the mobile device can generate tags 220 as a result of the user selecting the two star rating for occupant review 218, where the tags 220 are predetermined tags corresponding to a two star rating.

Although shown in FIG. 2B as including “broken lights”, “smelly”, “noisy”, “dirty”, “chairs missing”, “too hot”, “too cold”, and “water cooler empty” as tags as a result of a two star rating for occupant review 218, embodiments of the present disclosure are not so limited. For example, tags as a result of a two star rating can include other tags such as “light switches broken”, “conference room telephone broken”, “conference room projector too bright”, etc.

Tags can be generated based on the rating included in the occupant review of a building space. For example, a four star rating can include generated tags such as “comfortable chairs”, “comfortable temperature”, “relaxing wall colors”, “soothing paintings”, “clean”, etc. That is, different tags can be generated based on the level of rating a user gives for occupant review 218. Complimentary tags can be generated for higher ratings for an occupant review, whereas critical tags can be generated for lower ratings for an occupant review. Complimentary tags can give a facility manager suggestions for what occupants may like about a space, whereas critical tags can give a facility manager suggestions for what occupants may not like about a space (e.g., critical tags can be critical of the space), as is further described with respect to FIG. 4.

In some examples, a user can include a textual review to accompany occupant review 218 and tags 220. For example, a user can write a textual review including notes, thoughts, reasons, and/or ideas to include with occupant review 218 and tags 220. The textual review can allow a facility manager to glean additional information from an occupant review of a space in a building. The textual review can be input by a user of the mobile device to the mobile device via keyboard 222.

In some examples, a user can include a photograph to accompany occupant review 218 and tags 220. For instance, a user may generate occupant review 218 as a result of malfunctioning equipment, and the user can include a photograph of the malfunctioning equipment with occupant review 218 and tags 220. The photograph may allow a facility manager to quickly and easily locate, repair, and/or replace the malfunctioning equipment. The photograph can be input by a user to the mobile device via photograph submission 224.

FIG. 2C is an illustration of a display provided on a user interface of a mobile device showing a space review 225 with tags 226 for a lobby, generated in accordance with one or more embodiments of the present disclosure. As illustrated in FIG. 2C, space review 225 can include occupant review 226 and tags 228.

As illustrated in FIG. 2C, the mobile device can be located in the lobby space of the building (e.g., “Lobby”). A user of the mobile device can rate the Lobby of the building by giving an occupant review 226 by selecting a four star rating for the Lobby.

The mobile device can generate tags 228 in response to receiving occupant review 226. The tags generated by the mobile device can correspond to a type of space the mobile device is located in. For example, as illustrated in FIG. 2C, tags 228 for the Lobby can include “great chairs”, “awesome projector”, “very clean”, “right temperature”, “great lighting”, and “great leisure”. Tags 228 generated for the Lobby can be different than tags 220 generated for Conference Room 2Q47 (e.g., as previously described in connection with FIG. 2B). In other words, the tags generated in response to receiving an occupant review can vary based on the space the mobile device is located in.

Similar to the embodiment described in connection with FIG. 2B, different tags can be generated for different occupant reviews of the Lobby. The different tags for different occupant reviews can be generated based on the level of rating the user gives for occupant review 226. For example, complimentary tags can be generated for higher ratings for an occupant review, whereas critical tags can be generated for lower ratings for an occupant review.

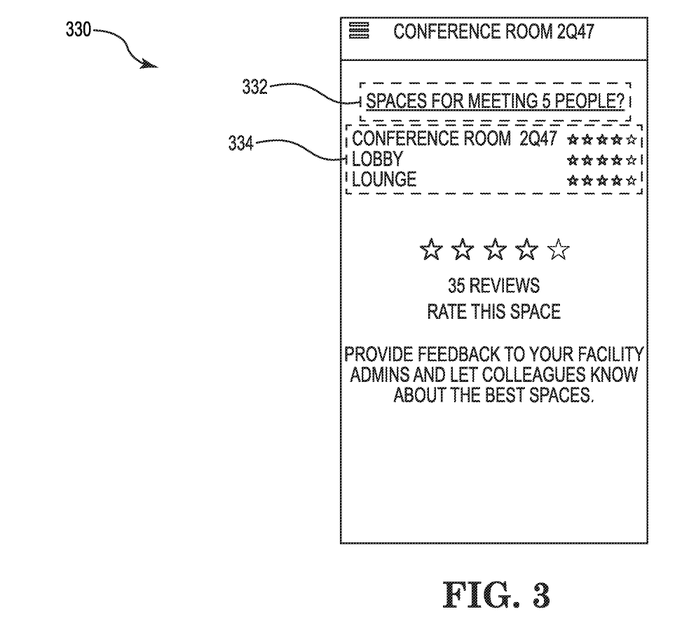

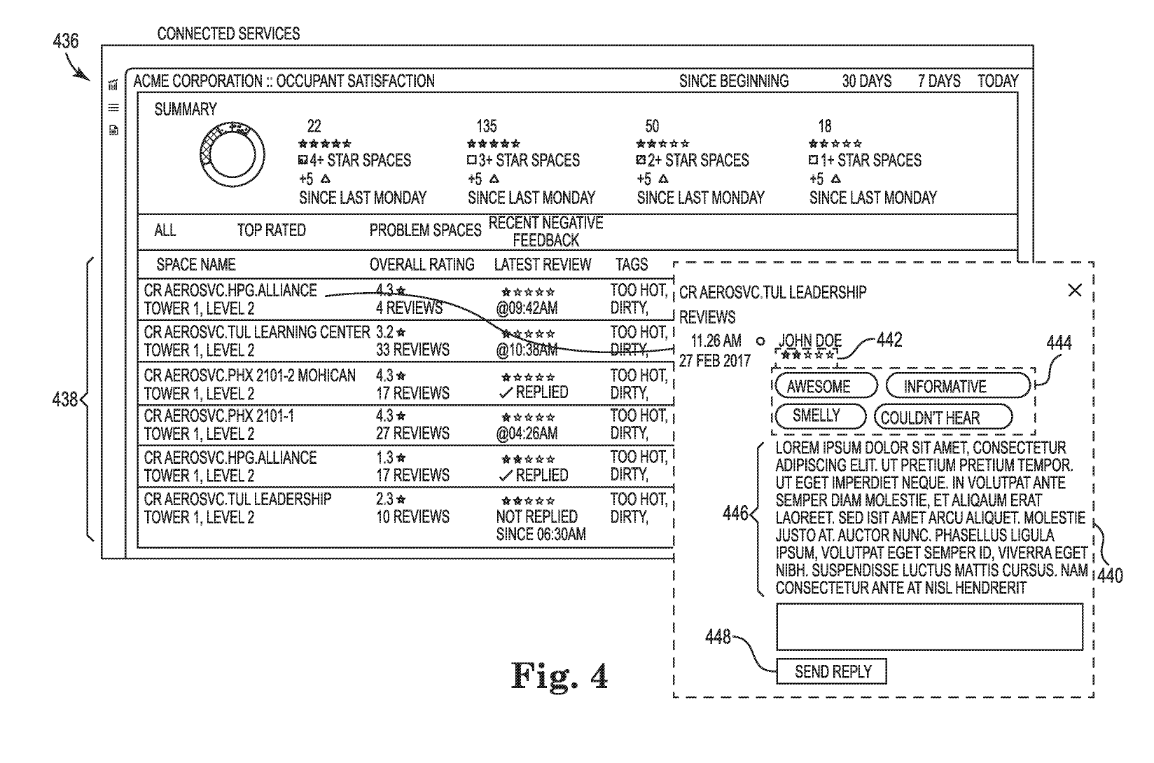

FIG. 3 is an illustration of a display provided on a user interface of a mobile device showing a space recommendation 330, generated in accordance with one or more embodiments of the present disclosure. As illustrated in FIG. 3, space recommendation 330 can include request for space recommendation 332 and list of candidate spaces 334.

The mobile device can receive a request for a space recommendation. As used herein, a “space recommendation” can include a recommended space within the building for a specified purpose. For example, a user may have a meeting with four other people. The user can request a space that may be ideal for a meeting with five people.

Although the space recommendation is described above as being a recommended space with the purpose being to meet with five people, embodiments of the present disclosure are not so limited. For example, a user may request a space recommendation for meeting with three people, hosting a lunch, conducting a presentation, leisure space, quiet space, good projectors, great lighting, etc.

The mobile device can generate a list of candidate spaces 334 in the building based on the request for space recommendation 332. For example, as illustrated in FIG. 3, the list of candidate spaces 334 for spaces for meeting five people can include “Conference Room 2Q47”, “Lobby”, and “Lounge”.

The spaces included in the list of candidate spaces 334 can be ranked based on ratings associated with past occupant reviews from other users. For example, the Conference Room 2Q47 can have a four star rating, the Lobby can have a four star rating, and the Lounge can have a four star rating. The user can review the list of candidate spaces 334 and select a space from the list of candidate spaces 334 with which to meet with five people. The user can select the space using the past occupant reviews.

Occupancy review of spaces, according to the present disclosure, can allow for an occupant of a space in a building using a mobile device to rate the space they are located in. The user can provide feedback to a facility manager or other person regarding the spaces of the building. The feedback can be complimentary (e.g., positive) feedback, allowing the facility manager to determine what users may like about a particular building space. The feedback can be critical (e.g., negative) feedback, allowing the facility manager to determine what users may not like about a particular building space. Critical feedback may also alert a facility manager to malfunctioning equipment, allowing a fast and efficient way for a user of a mobile device to report malfunctioning equipment in the building.

FIG. 4 is an illustration of a display provided on a user interface of a computing device showing a feedback dashboard 436, generated in accordance with one or more embodiments of the present disclosure. As illustrated in FIG. 4, feedback dashboard 436 can include occupant reviews 438 and particular occupant review 440. Particular occupant review 440 can include rating 442 of the space, tags 444 associated with the rating of the space, textual review 446 of the space, and send received text 448.

The computing device can receive occupant reviews 438 from mobile devices regarding spaces in a building. For example, occupants may be located in various spaces in the building. The occupants may be users of mobile devices. Each mobile device can be associated with a respective user (e.g., a respective occupant).

Users of the mobile devices in the building can rate spaces they are occupying by generating an occupant review of the space. As previously described in connection with FIGS. 2A-2C and FIG. 3, a user of a mobile device can rate the space they are located in. The mobile device can send the occupant review to the computing device.

An occupant review included in occupant reviews 438 from a mobile device can include a location of the mobile device in the building and a rating of a space corresponding to the location of the mobile device. For example, the mobile device may be located in a lobby of the building, and a user of the mobile device can rate the lobby four stars. The mobile device can send the occupant review, including the location of the mobile device being the lobby and the four star rating, to the computing device.

Although the occupant review is described above as including the location of the mobile device in the building and the rating of the space corresponding to the location of the mobile device, embodiments of the present disclosure are not so limited. For example, an occupant review can include tags associated with the rating of the space, identification information corresponding to a user of the mobile device (e.g., name of the user, gender information of the user, a job title of the user, user permissions of the user, and/or physical information of the user, including height, weight, hair color, and/or eye color, etc.), a textual review of the space, and/or a photograph of the space, as is further described herein.

The computing device can generate feedback dashboard 436 based on the received occupant reviews from mobile devices regarding the spaces in the building. For example, feedback dashboard 436 can be generated based on occupant reviews received from various mobile devices located in various spaces in the building. The occupant reviews can correspond to spaces in which respective mobile devices are located, as previously described in connection with FIGS. 2A-2C and FIG. 3. Feedback dashboard 436 can categorize the spaces of the building according to the received occupant reviews 438, as is further described herein.

Occupant reviews 438 can be sent to other mobile devices. For example, as previously described with respect to FIG. 3, a user of a mobile device can request a space recommendation. The computing device can send occupant reviews 438 to the mobile device such that the user can select a space that may be ideal for the purpose for which the user is requesting a space recommendation.

For example, the user may request a space recommendation for a conference room. The computing device can send occupant reviews of conference rooms to the mobile device, where a user of the mobile device can select a conference room suited for the purpose of the user based on occupant reviews from other mobile devices.

Feedback dashboard 436 can include spaces of the building ranked according to occupant reviews 438. In some examples, occupant reviews 438 can be ranked by highest to lowest occupant ratings (e.g., five star ratings are shown first, one star ratings are shown last) of the occupant reviews 438. In some examples, occupant reviews 438 can be ranked by lowest to highest occupant ratings (e.g., one star ratings are shown first, five star ratings are shown last) of the occupant reviews 438. The occupant ratings of the occupant reviews 438 can be averaged ratings for the building spaces.

Occupant reviews 438 can be displayed according to received reviews in a predetermined period of time. In some examples, occupant reviews 438 can be displayed based on recent negative ratings (e.g., recent two star ratings) for the previous two days. In some examples, occupant reviews 438 can be displayed based on recent positive ratings (e.g., recent four star ratings) for the previous week.

Occupant reviews 438 can be displayed according to received reviews by a type of space of the building. In some examples, occupant reviews of conference rooms can be displayed. In some examples, occupant reviews of offices can be displayed.

Occupant reviews 438 can be displayed according to trends in the received reviews. For example, occupant reviews of spaces having a threshold number of reviews for a threshold time period can be displayed. For instance, offices having less than three star ratings in the last seven days can be displayed.

Occupant reviews 438 can be displayed according to a quantity of reviews received. For example, spaces having more than a threshold number of reviews can be displayed (e.g., spaces having higher than five reviews). A facility manager may utilize the quantity of reviews more than a threshold number to determine what spaces are being reviewed by occupants and why. Conversely, spaces having less than a threshold number of reviews can be displayed (e.g., spaces having less than five reviews), and a facility manager may determine what spaces are not being reviewed by occupants and why.

Occupant reviews 438 can be displayed according to a quantity of textual reviews received. For example, spaces having more than a threshold number of textual reviews received can be displayed.

In some examples, spaces can be categorized and displayed on feedback dashboard 436 by occupant rating of the space. For example, feedback dashboard 436 can show the quantity of spaces with four star ratings, the quantity of spaces with three star ratings, the quantity of spaces with two star ratings, the quantity of spaces with one star ratings, etc. The quantity of spaces categorized by rating can be categorized by a threshold period of time. For example, the quantity of spaces with four star ratings can be the quantity of spaces with four star ratings received in the past five days.

The computing device can display occupant reviews of a space of the building in response to a selection of the space of the building. For example, a facility manager can select a particular space of the building, and feedback dashboard 436 can display occupant reviews for the selected particular space.

The computing device can receive a selection of a particular occupant review 440 via feedback dashboard 436, and the computing device can display the particular occupant review 440. For instance, a facility manager can select a particular occupant review 440 included in a list of occupant reviews corresponding to a particular space of a building. For example, a particular occupant review 440 for a LEADERSHIP space can be displayed. The particular occupant review 440 can allow a facility manager or other user to view individual occupant reviews and perform various actions, as is further described herein.

As illustrated in FIG. 4, particular occupant review 440 can include a name of a user corresponding to a particular mobile device the particular occupant review 440 was received from. For example, user John Doe gave an occupant review of the “LEADERSHIP” space included in a building. John Doe gave the occupant review at 11:26 AM on Feb. 27, 2017.

Particular occupant review 440 can include a rating 442 of the space. For example, user John Doe gave the rating 442 of the LEADERSHIP space two stars.

Particular occupant review 440 can include tags 444. For example, user John Doe selected tags 444 to accompany the two star rating 442 that include “awesome”, “informative”, “smelly”, “couldn't hear”. That is, user John Doe rated LEADERSHIP space two stars as a result of the space being awesome, informative, but smelly, and hard to hear.

Particular occupant review 440 can include a textual review 446. For example, user John Doe further included a textual review 446 with rating 442 and tags 444 in the particular occupant review 440 submitted for the LEADERSHIP space. The textual review 446 can include further textual information from a user. For instance, a user may rate a space two stars and select associated tags, as well as include further notes, thoughts, reasons, and/or ideas with the occupant review, among other textual information that could be included in the textual review 446.

Although not illustrated in FIG. 4 for clarity and so as not to obscure embodiments of the present disclosure, particular occupant review 440 can include a photograph. For example, user John Doe may include a photograph in particular occupant review 440 submitted for the LEADERSHIP space showing malfunctioning equipment or a location of malfunctioning equipment. The photograph may allow a facility manager to quickly locate and repair or replace the malfunctioning equipment.

Although the photograph is described above as showing malfunctioning equipment or locations of malfunctioning equipment, embodiments of the present disclosure are not so limited. For example, a user of a mobile device can include a photograph with an occupant review for any other reason.

A user of feedback dashboard 436, such as a facility manager, can reply to a user of the mobile device that particular occupant review 440 was received from. For example, the computing device can receive text from the facility manager via a user input in response to a selection of particular occupant review 440, and send the received text to the particular mobile device corresponding to the particular occupant review 440. For instance, a facility manager can send a reply message to the user of the mobile device to, for example, thank the user, acknowledge, or ask questions about the particular occupant review 440.

The computing device can generate a notification in response to receiving an occupant review 438 that includes a rating of a space that is less than a threshold rating. For example, the computing device can generate a notification in response to an occupant review that includes a rating of a space that is less than three stars. The notification can be displayed via a user interface of a display of the computing device and/or sent to a mobile device of a user of feedback dashboard 436, such as a facility manager.

The feedback dashboard, according to the present disclosure, can allow a user of the feedback dashboard, such as a facility manager or other personnel, to determine ratings of spaces. The feedback dashboard can allow the facility manager to determine which spaces in the building are receiving complimentary feedback and which spaces are receiving critical feedback. The critical feedback can allow a facility manager to make changes to spaces receiving critical feedback. The facility manager may utilize the complimentary feedback in making changes to spaces receiving the critical feedback or for other purposes.

FIG. 5 is an example of a computing device 550 and a mobile device 506 for occupancy review of spaces, in accordance with one or more embodiments of the present disclosure. As illustrated in FIG. 5, computing device 552 can include a user interface 557, memory 556 and a processor 554 for occupancy review of spaces in accordance with the present disclosure. Mobile device 506 can include a user interface 562, memory 560 and a processor 558 for occupancy review of spaces in accordance with the present disclosure.

Computing device 552 can be, for example, a laptop computer, a desktop computer, and/or a mobile device (e.g., a smart phone, tablet, personal digital assistant, smart glasses, a wrist-worn device, etc.), and/or redundant combinations thereof, among other types of computing devices. Mobile device can be, for example, a device that is (or can be) carried and/or worn by a user. For example, mobile device 506 can be a phone (e.g., a smart phone), a tablet, a personal digital assistant (PDA), smart glasses, and/or a wrist-worn device (e.g., a smart watch), among other types of mobile devices.

The memory 556, 560 can be any type of storage medium that can be accessed by the processor 554, 558 to perform various examples of the present disclosure. For example, the memory 556, 560 can be a non-transitory computer readable medium having computer readable instructions (e.g., computer program instructions) stored thereon that are executable by the processor 554, 558 for occupancy review of spaces in accordance with the present disclosure.

The memory 556, 560 can be volatile or nonvolatile memory. The memory 556, 560 can also be removable (e.g., portable) memory, or non-removable (e.g., internal) memory. For example, the memory 556, 560 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 556, 560 is illustrated as being located within computing device 552 and mobile device 506, respectively, embodiments of the present disclosure are not so limited. For example, memory 556, 560 can also be located internal to another computing resource (e.g., enabling computer readable instructions to be downloaded over the Internet or another wired or wireless connection).

As illustrated in FIG. 5, computing device 550 includes a user interface 557 and mobile device 506 includes user interface 562. In some examples, the user interface 562 of mobile device 506 can display an occupant review selection of a space (e.g., as previously described in connection with FIGS. 2A-2C and FIG. 3) in a single integrated display. In some examples, the user interface 557 of computing device 552 can display a feedback dashboard (e.g., as previously described in connection with FIG. 4) in a single integrated display. A user (e.g., operator) of computing device 552 can interact with computing device 552 via user interface 557 and a user (e.g., operator) of mobile device 506 can interact with mobile device 506 via user interface 562, respectively. For example, user interface 557 can provide (e.g., display and/or present) information to the user of computing device 552, and/or receive information from (e.g., input by) the user of computing device 552. Further, user interface 562 can provide (e.g., display and/or present) information to the user of mobile device 506, and/or receive information from (e.g., input by) the user of mobile device 506. For instance, in some embodiments, user interface 557, 562 can be a graphical user interface (GUI) that can provide and/or receive information to and/or from the user of computing device 552 and mobile device 506, respectively. The display can be, for instance, a touch-screen (e.g., the GUI can include touch-screen capabilities). Alternatively, a display can include a television, computer monitor, mobile device screen, other type of display device, or any combination thereof, connected to computing device 552 and/or mobile device 506 and configured to receive a video signal output from the computing device 552 and/or mobile device 506.

As an additional example, user interface 557 can include a keyboard and/or mouse the user can use to input information into computing device 552. Embodiments of the present disclosure, however, are not limited to a particular type(s) of user interface.

User interface 557, 562 can be localized to any language. For example, user interface 557, 562 can display the occupancy review of spaces in any language, such as English, Spanish, German, French, Mandarin, Arabic, Japanese, Hindi, etc.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for occupancy reviews of spaces, comprising:
a memory;
a processor configured to execute executable instructions stored in the memory to:
receive occupant reviews from mobile devices regarding spaces in a building, wherein an occupant review from a mobile device of the mobile devices includes:
a location of a mobile device in the building; and
a rating of a space corresponding to the location of the mobile device;
generate a feedback dashboard based on the received occupant reviews from the mobile devices regarding the spaces in the building; and
a user interface configured to display the feedback dashboard in a display.

2. The computing device of claim 1, wherein the feedback dashboard includes spaces of the building ranked according to occupant reviews.

3. The computing device of claim 1, wherein the occupant review from the mobile device of the mobile devices further includes at least one of:
tags associated with the rating of the space;
identification information corresponding to a user of the mobile device;
a textual review of the space; and
a photograph of the space.

4. The computing device of claim 1, where the spaces in the building are displayed in the feedback dashboard according to at least one of:
received occupant reviews in a predetermined period of time;
trends in the received occupant reviews;
received occupant reviews by a type of space of the building;
quantity of occupant reviews received; and
quantity of textual reviews received.

5. The computing device of claim 1, wherein the processor is configured to execute the instructions to display occupant reviews of a space of the building in response to a selection of the space via a user input.

6. The computing device of claim 5, wherein the processor is configured to execute the instructions to display a particular occupant review of the occupant reviews of the space of the building in response to a selection of the particular occupant review via a user input.

7. The computing device of claim 1, wherein the processor is configured to execute the instructions to display a textual review of a space of the building in response to a selection of the space via a user input.

8. The computing device of claim 1, wherein the processor is configured to execute the instructions to:
receive text via a user input in response to a selection of a particular occupant review; and
send the received text to a particular mobile device corresponding to the particular occupant review.

9. The computing device of claim 1, wherein the processor is configured to execute the instructions to generate a notification in response to receiving an occupant review that includes a rating of a space that is less than a threshold amount.

10. The computing device of claim 1, wherein the location of the mobile device in the building is based on location beacons included in the building.

11. A non-transitory computer readable medium having computer readable instructions stored thereon that are executable by a processor to:
receive occupant reviews from mobile devices regarding spaces of a building, wherein each occupant review from a respective mobile device includes:
a location of a respective mobile device of the mobile devices in the building; and
a rating of a space corresponding to the location of the respective mobile device;
generate a feedback dashboard based on the received occupant reviews, wherein the feedback dashboard includes spaces of the building categorized according to the received occupant reviews; and
display the feedback dashboard in a display.

12. The computer readable medium of claim 11, wherein the computer readable instructions are executable by the processor to:
receive a selection of a particular occupant review via the feedback dashboard; and
display the particular occupant review via the display.

13. The computer readable medium of claim 12, wherein the instructions to display the individual review include instructions executable by the processor to display at least one of:
a name of a user corresponding to a particular mobile device of the mobile devices the particular occupant review was received from;
tags included with the particular occupant review;
a textual review included with the particular occupant review; and
a photograph included with the particular occupant review.

14. The computer readable medium of claim 11, wherein the computer readable instructions are executable by the processor to send the occupant reviews to other mobile devices.

15. A mobile device for occupancy reviews of spaces, comprising:
a memory;
a processor configured to execute executable instructions stored in the memory to:
determine, based on location beacons included in a building, a location of the mobile device in the building;
generate, based on the determined location, an occupant review selection of a space corresponding to the location of the mobile device;
receive an occupant review of the space via a user input; and
send the occupant review to a remove server.

16. The mobile device of claim 15, wherein the processor is configured to execute the instructions to generate tags in response to receiving the occupant review, wherein the tags are generated according to a rating of the space.

17. The mobile device of claim 16, wherein the tags correspond to a type of space the mobile device is located in.

18. The mobile device of claim 15, wherein the processor is configured to execute the instructions to:
receive a request for a space recommendation; and
generate a list of candidate spaces in the building based on the request for the space recommendation.

19. The mobile device of claim 15, wherein the processor is configured to execute the instructions to receive a location search query.

20. The mobile device of claim 19, wherein the processor is configured to execute the instructions to determine the location of the mobile device in the building in response to a selection of a location via the location search query.
